(19) United States
(12) Patent Application Publication
(10) Pub. No.: US 2014/0217746 A1
(43) Pub. Date: Aug. 7, 2014

(54) METHOD FOR REGULATING THE OPERATION OF A GENERATOR SET

(71) Applicants: Samuel Moser, Gond-Pontouvre (FR); Jean-Marie Andrejak, Saint Yrieix (FR); Patrice Betge, L'Isle D'Espagnac (FR)

(72) Inventors: Samuel Moser, Gond-Pontouvre (FR); Jean-Marie Andrejak, Saint Yrieix (FR); Patrice Betge, L'Isle D'Espagnac (FR)

(73) Assignee: MOTEURS LEROY-SOMER, Angouleme (FR)

(21) Appl. No.: 14/342,458

(22) PCT Filed: Aug. 1, 2012
(86) PCT No.: PCT/IB2012/053923

§ 371 Date: Mar. 3, 2014

(30) Foreign Application Priority Data
Sep. 1, 2011 (FR) 11 57724

(51) Int. Cl. F02D 29/06

(52) U.S. Cl. CPC F02D 29/06
USPC 290/40 B

(57) ABSTRACT

The present invention relates to a method for regulating the injection of fuel into a combustion engine of an electric generator set including an alternator driven by the electric motor, the electric generator set including at least one sensor sensing the speed of the combustion engine and using a control loop having at least at input a signal coming from the sensor, the method involving the following steps: detecting an increase in load on the output side of the alternator from at least one electrical quantity on the output side of the alternator and, when an increase in load is detected, substituting at least one predefined value for at least one value delivered by the speed sensor at input to the control loop.

The present invention relates to the regulation of alternators.

The engines driving generator sets are equipped with electronic speed regulators, incorporated in the engine fuel injection system. The regulation of the speed of these engines relies, among other things, on the measurement of the speed of rotation of the shaft of the engine by a sensor counting the number of teeth of a crown ring passing in front of the sensor.

An injection computer of the speed computer uses the signal delivered by this sensor to determine the fuel injection level so as to maintain the speed at a predefined value, but has no direct knowledge of the load level which is applied to the engine, because there is no economical means for informing the computer of this load level.

Each load variation applied to the engine, whether it be an increase or a reduction, is reflected in a transient reduction or increase in the engine speed that the speed regulator tries to correct by a suitable injection level.

In the known generator sets, it is only the knowledge of the speed and of the injection level that lets the computer determine the load level which is applied to the engine.

It is known from U.S. Pat. No. 5,703,410 to monitor the excitation current of an alternator and the fuel injection based on the knowledge of the rectified voltage at the output of the alternator.

It is also known from the application EP 1 938 447 to control the fuel intake actuator of a generator set by virtue of a monitoring device delivering a control signal replacing an output signal of the speed regulator when a load variation is detected.

Turbo-charged engines are being increasingly widely used in generator sets.

One drawback with these engines is the degradation of their performance levels if the turbocharging cannot be initiated correctly. As it happens, a sudden increase in the load is likely to slow down the engine too much for a correct operation thereof.

There is a need to further improve the performance levels of the generator sets, notably on increases in the load, in order, among other things, to facilitate the use of turbo-charged engines.

The invention aims to at least partly address this need and achieves this, according to one of its aspects, by virtue of a method for regulating the injection of fuel into a fuel engine of a generator set comprising an alternator driven by the fuel engine, the generator set having at least one sensor of the speed of the fuel engine and implementing a regulation loop having as input at least one signal originating from the speed sensor, the method comprising the following steps:
detecting an increase in the load at the output of the alternator based on at least one electrical quantity at the output of the alternator, and
when an increase in the load is detected, replacing at least one value delivered by the speed sensor as input for the regulation loop with at least one predefined value.

The term “predefined value” should be understood to mean a constant value or a computed value that can vary according to certain parameters, for example the level of power. It is thus possible to take account of the behaviour of the engine according to the load, this behaviour being different in the on-load state and off-load.

A number of predefined values can be substituted according to the crossing of a number of respective thresholds, for example. The computation may involve different parameters, for example the power level.

By virtue of the invention, by deliberately modifying the indication originating normally from the speed sensor of the engine at the input of the regulation loop, it is possible to apply to the regulation loop a value anticipating the trend of the load even before the sensor is able to detect it and even before the motor has significantly dropped in speed.

It is thus possible, for example, to increase the injection of fuel as soon as the increase in the load is detected, without waiting for this increase in the injection of fuel to be triggered by the detection of a slowing down of the speed of the engine by the engine speed regulator.

The expression “injection of fuel” should be understood generally to mean the control of the power of the fuel engine.

The expression “speed sensor” should be understood to mean a sensor of a quantity representative of the speed of the engine, for example a sensor delivering pulses at a frequency proportional to the speed of rotation of the shaft of the fuel engine.

The electrical quantity at the output of the alternator may be representative of at least one of the current flowing through the main armature winding of the alternator, the voltage at the output of the alternator and the active power at the output of the alternator. The increase in the load is reflected by an increase in the active power.

The speed of rotation of the fuel engine is linked to the frequency of the voltage at the output of the alternator.

The value used to replace, according to the invention, the one delivered by the speed sensor may follow a predefined control law aiming to allow the engine to correct the variation of the load by a good injection dosage.

In the absence of detection of the increase in the load at the output of the alternator, the value delivered by the speed sensor of the fuel engine may be used as input for the regulation loop, the regulation system according to the invention resuming a behaviour that is “transparent” with respect to the speed sensor.

The replacement can thus occur only in case of load variation.

The output of the alternator can be linked to a three-phase network, the nominal speed of rotation of the fuel engine being, for example, 1500 rpm and the nominal output voltage between phases of the alternator being, for example, 400 V.

The invention makes it possible to improve, among other things, the response time of the generator set when the load varies.

The replacement according to the invention of the value delivered by the speed sensor with a predefined value can be combined with other regulation measures aiming to improve the operation of the generator set, for example measures aiming to act on the operation of the alternator to reduce the excitation current and reduce the torque associated with the increase in the load for the time needed for the power of the engine to increase.

Another subject of the invention, according to another of its aspects, is a system for regulating the injection of fuel into a fuel engine of a generator set to implement the method according to the invention, the generator set including at least one sensor of the speed of the fuel engine and a speed regulator comprising an injection computer, the speed regulator of the engine receiving as input a signal from the speed sensor and controlling the injection of the fuel, the regulation system being configured to:
detect an increase in the load at the output of the alternator, or receive a corresponding indication,
when the increase in the load is detected, replace at least one value delivered by the speed sensor with at least one different value as input for the speed regulator of the engine so as to simulate a slowing down of the engine, and thus cause the speed regulator of the engine to modify the dosage of the injection in order to accelerate.

Thus, the regulation system can cause the engine to accelerate as soon as the application of the load is detected even before the engine has actually dropped in speed.

The regulation system can be configured to, in the absence of detection of the increase in the load at the output of the alternator or reception of the corresponding indication, use, in the regulation loop, the value delivered by the speed sensor of the fuel engine.

The regulation system can itself detect the increase in the load, based on, for example, the knowledge of the power delivered by the alternator. As a variant, the regulation system receives this indication for example from a voltage regulator with which the alternator is equipped.

The regulation system can transmit, in steady state operation, the indications from the speed sensor to the speed regulator of the fuel engine without modifying them, but, as soon as an increase in load above a predefined threshold is detected, the regulation system can modify the signal sent to the speed regulator to make it believe that the speed of the engine has decreased, whereas the drop in speed has not yet occurred.

One advantage of such a regulation system is to be able to be installed on existing generator sets, without modifying the speed regulator of the fuel engine.

All the features of the invention itemized above for the method are also valid for the regulation system.

The invention can be better understood from reading the following description of a nonlimiting exemplary implementation thereof, and on studying the appended drawing in which:

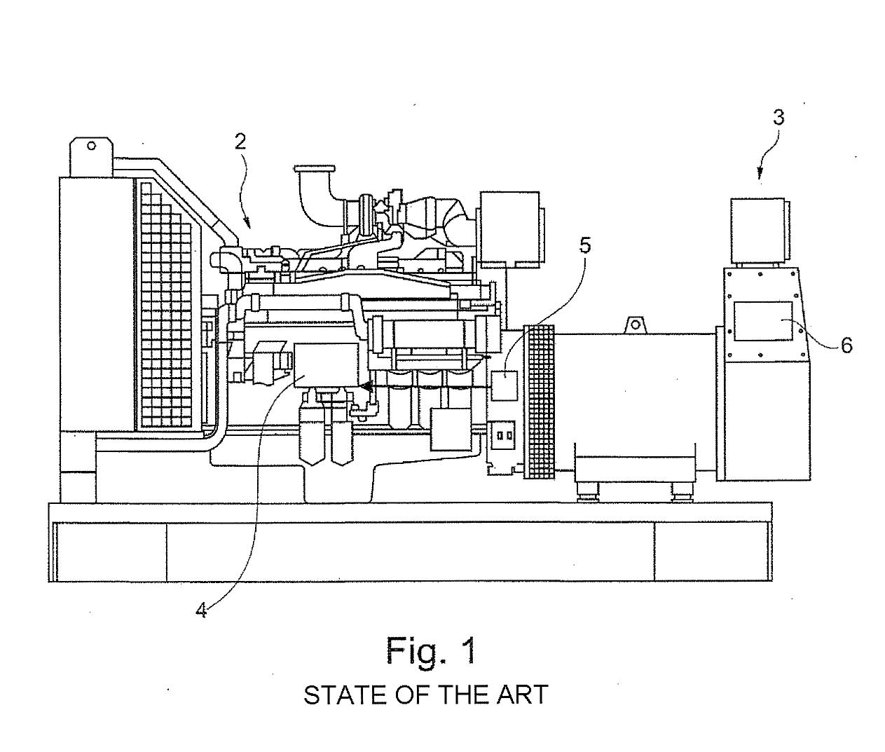

FIG. 1 represents a generator set according to the prior art,

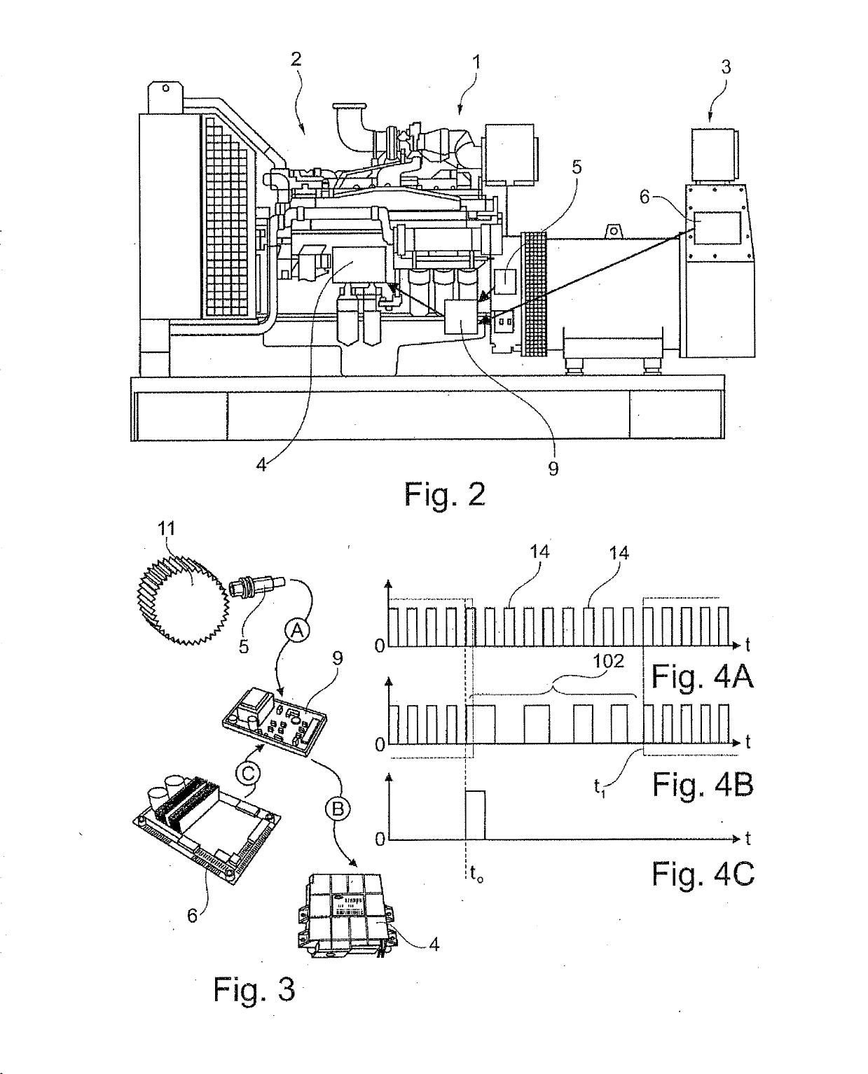

FIG. 2 represents a generator set according to the invention,

FIG. 3 illustrates the relationships between different constituent elements of the generator set according to the invention, and

FIGS. 4A, 4B and 4C represent different signals on implementing the method according to the invention.

A generator set according to the prior art comprises, as illustrated in FIG. 1, a fuel engine 2 and an alternator 3, to which a load, not represented, is applied.

The engine 2 includes a speed regulator 4 comprising an injection computer which computes the injection (or the control of the gases) of the engine in order for the speed of rotation to be kept constant at a predefined value which depends on the polarity of the alternator and on the desired frequency of the output current, for example 1500 rpm for a frequency of 50 Hz.

The engine 2 includes a speed sensor 5 which can be, for example, inductive, capacitive or optical.

The sensor 5 is, for example, arranged in front of a crown ring 11 driven in rotation by the engine, as illustrated in FIG. 3, and delivers pulses 14 at a frequency proportional to the speed of rotation, as illustrated in FIG. 4A.

The speed regulator 4 receives the signal from the sensor 5 and computes the appropriate fuel injection level to maintain the speed, without knowing the level of load applied to the alternator 3.

The alternator 3 includes, as illustrated in FIG. 1, a voltage regulator 6, which monitors the voltage at the output of the alternator and determines the excitation current to be applied to maintain a predefined voltage amplitude, for example 400 V three-phase.

The generator set 1 according to the invention includes, as illustrated in FIG. 2, a regulation system 9 which receives the signal from the speed sensor 5 and which is linked to the speed regulator 4 of the engine 2. This regulation system 9 may comprise a module separate from the speed regulator 4 of the engine 2 and also separate, where appropriate, from the voltage regulator 6 of the alternator 3.

The regulation system 9 is arranged to detect a load variation, based on the knowledge of the voltage at the output of the alternator. As a variant, it is the voltage regulator 6 which provides this detection and sends the corresponding indication to the regulation system 9.

FIG. 4C illustrates the application of a load impact at the instant t₀.

Prior to the application of the load impact, in nominal operation, the regulation system 9 transparently retransmits to the speed regulator 4 of the engine 2 the signal delivered by the sensor 5, as illustrated in FIG. 4B.

When the load impact occurs at the instant t₀, a power variation is detected by the regulation system 9 or by the voltage regulator 6, and the regulation system 9 sends to the speed regulator 4 of the engine 2 a replacement signal 102, as illustrated in FIG. 4B, before the sensor 5 has detected a variation of the speed.

The replacement signal 102 simulates a slowing down of the engine 2, which causes the speed regulator 4 to increase the power of the engine to accelerate and counter this slowing down.

The flow rate of fuel injected into the fuel engine 2 is thus modified by the regulation system 9, through the intermediary of the speed regulator 4.

When the voltage measured at the output of the alternator 3 reflects the fact that the increase in the power of the engine 2 has countered the tendency to slow down linked to the impact of the load, that is to say, when the replaced signal becomes substantially the same as the signal from the speed sensor 5 before load impact, the regulation system 9 can once again transmit, at the instant t₁, to the speed regulator 4, the signal from the sensor 5 transparently, as illustrated in FIG. 4B.

The invention is not limited to the example which has just been described. For example, other regulation measures can be combined with the invention.

The expression “comprising a” should be understood to be synonymous with “comprising at least one”, unless specified otherwise.

1. Method for regulating the injection of fuel into a fuel engine of a generator set comprising an alternator driven by the fuel engine, the generator set having at least one sensor of the speed of the fuel engine and implementing a regulation loop having at least as input a signal originating from the sensor, the method comprising the following steps:
detecting an increase in the load at the output of the alternator based on at least one electrical quantity at the output of the alternator, and
when an increase in the load is detected, replacing at least one value delivered by the speed sensor as input for the regulation loop with at least one predefined value.

2. Method according to claim 1, in which the electrical quantity at the output of the alternator is representative of at least one of the current flowing through the main armature winding of the alternator, the voltage at the output of the alternator and the active power at the output of the alternator.

3. Method according to claim 1, in which, in the absence of detection of the increase in the load at the output of the alternator, the value delivered by the sensor is used as input for the regulation loop.

4. Method according to claim 1, the predefined value depending on the power level.

5. System for regulating the injection of fuel into a fuel engine of a generator set comprising an alternator driven by the fuel engine, the generator set including at least one sensor of the speed of the fuel engine and a speed regulator comprising an injection computer, the speed regulator of the engine receiving as input a signal from the speed sensor and controlling the injection of the fuel, the regulation system being configured to:
detect an increase in the load at the output of the alternator, or receive a corresponding indication,
when the increase in the load is detected, replace at least one value delivered by the speed sensor with at least one different value as input for the speed regulator of the engine so as to simulate a slowing down of the engine, and thus cause the speed regulator of the engine to modify the dosage of the injection in order to accelerate.

6. Regulation system according to claim 5, being configured to, in the absence of detection of the increase in the load at the output of the alternator or of reception of the corresponding indication, transmit to the speed regulator of the engine the value delivered by the speed sensor.

7. System according to claim 5, the replacement value depending on the power level.
